(19) United States
(12) Patent Application Publication
(10) Pub. No.: US 2022/0309244 A1
(43) Pub. Date: Sep. 29, 2022

(54) COMPUTER-READABLE RECORDING MEDIUM STORING MACHINE LEARNING PROGRAM, MACHINE LEARNING METHOD, AND INFORMATION PROCESSING DEVICE

(71) Applicant: FUJITSU LIMITED, Kawasaki-shi (JP)

(72) Inventor: Takuya Makino, Kawasaki (JP)

(73) Assignee: FUJITSU LIMITED, Kawasaki-shi (JP)

(21) Appl. No.: 17/589,555

(22) Filed: Jan. 31, 2022

(30) Foreign Application Priority Data
Mar. 29, 2021 (JP) 2021-055116

(51) Int. Cl. G06F 40/284; G06N 7/00

(52) U.S. Cl. CPC G06F 40/284; G06N 7/005

(57) ABSTRACT

A non-transitory computer-readable recording medium stores a machine learning program for causing a computer to execute processing including: calculating a first attention score of each token divided from a target document of a token sequence in parallel; calculating a coverage score of each token on the basis of the calculated first attention score of each token; calculating a second attention score of each token in the token sequence in parallel on the basis of the calculated coverage score of each token; and calculating a probability that the token is included in a summary sentence from the target document for each token on the basis of the calculated second attention score of each token.

### CROSS-REFERENCE TO RELATED APPLICATION

This application is based upon and claims the benefit of priority of the prior Japanese Patent Application No. 2021-55116, filed on Mar. 29, 2021, the entire contents of which are incorporated herein by reference.

### FIELD

The embodiment discussed herein is related to a machine learning program, a machine learning method, and an information processing device.

### BACKGROUND

Typically, automatic summarization has been known for creating a summary sentence from a document such as newspapers or websites using a machine learning model such as a neural network. As a machine learning model used to create a summary sentence, there is a summary model based on a long short-term memory (LSTM) considering a coverage (mechanism not to give high attention probability (referred to as attention score) to the same word in original document many times).

Furthermore, as a machine learning model with high summarization accuracy in recent years, a summary model based on the Transformer has been known.

Get To The Point: Summarization with Pointer-Generator Networks, ACL2017; The Illustrated Transformer—Jay Alammar—Visualizing machine learning one concept at a time. [accessed 2021/3/10], Internet<URL: http://jalammargithub.io/illustrated-transformer/>; and Kazuki Akiyama, Akihiro Tamura, Takashi Ninomiya, Hiroaki Obayashi, “Generated Automatic Summarization by BERTSUM Considering Coverage”, Proceedings of the 26th Annual Meeting of the Natural Language Processing Society, pp. 449-452, March 2020 are disclosed as related art.

However, the summary model based on the Transformer has a problem in that a coverage is not considered and accuracy deterioration, for example, repeated generation of words occurs.

### SUMMARY

According to an aspect of the embodiments, non-transitory computer-readable recording medium stores a machine learning program for causing a computer to execute processing including: calculating a first attention score of each token divided from a target document of a token sequence in parallel; calculating a coverage score of each token on the basis of the calculated first attention score of each token; calculating a second attention score of each token in the token sequence in parallel on the basis of the calculated coverage score of each token; and calculating a probability that the token is included in a summary sentence from the target document for each token on the basis of the calculated second attention score of each token.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an information processing device according to an embodiment;

FIG. 2 is an explanatory diagram for explaining a calculation example of a first attention probability;

FIG. 3 is an explanatory diagram for explaining a coverage calculation example;

FIG. 4 is an explanatory diagram for explaining a calculation example of a second attention probability;

FIG. 5 is a flowchart illustrating an operation example of the information processing device according to the embodiment;

FIG. 6 is an explanatory diagram for explaining an example of a learning case;

FIG. 7 is a flowchart illustrating an operation example of the information processing device according to the embodiment; and

FIG. 8 is an explanatory diagram for explaining an example of a computer configuration.

### DESCRIPTION OF EMBODIMENTS

The summary model based on the Transformer can perform calculation in parallel in a time direction (word (token) sequence of correct summary) at the time of learning and can execute processing at higher speed than the LSTM.

For example, the summary model based on the Transformer performs calculation in parallel in the time direction at the time of learning and calculates generation probabilities of tokens in a correct summary (and attention score of each token) in parallel. Because the coverage is a sum of the attention scores at past times in the time direction at the time of learning, the Transformer that performs calculation in parallel cannot use the coverage.

In one aspect, an object is to provide a machine learning program, a machine learning method, and an information processing device that can improve summarization accuracy.

Hereinafter, a machine learning program, a machine learning method, and an information processing device according to an embodiment will be described with reference to the drawings. Configurations having the same functions in the embodiments are denoted with the same reference numerals, and redundant description will be omitted. Note that the machine learning program, the machine learning method, and the information processing device described in the following embodiment are merely examples, and do not limit the embodiment. Furthermore, each of the embodiments below may be appropriately combined unless otherwise contradicted.

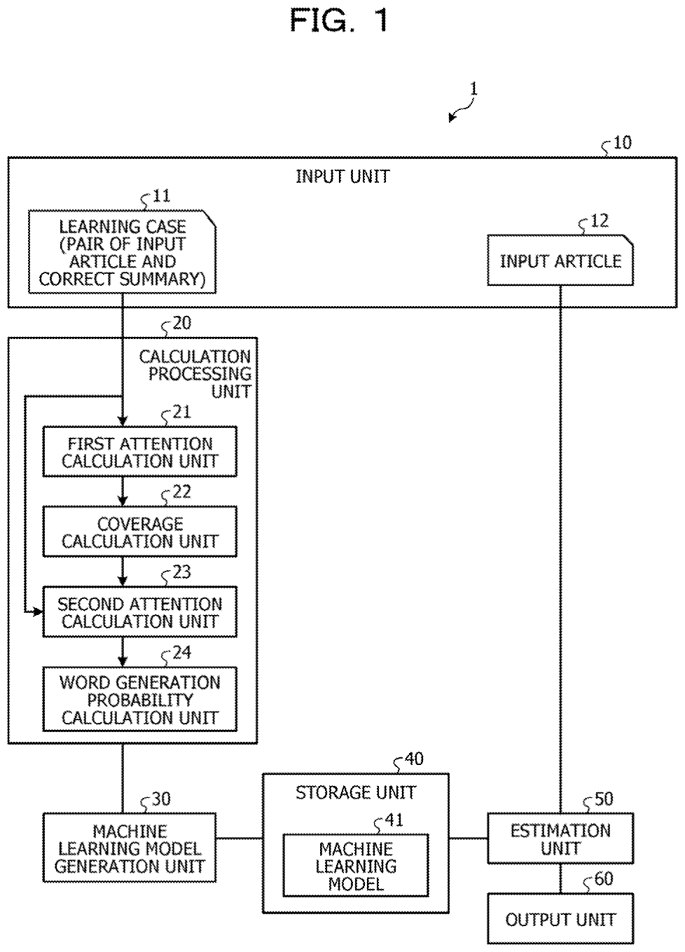

FIG. 1 is a block diagram illustrating an exemplary functional configuration of the information processing device according to the embodiment. As illustrated in FIG. 1, an information processing device 1 performs machine learning of a machine learning model 41 that generates a summary sentence from a learning case 11 in which an input article and a correct summary sentence for the input article are paired. Then, the information processing device 1 generates a summary sentence for an input article 12 using the learned machine learning model 41.

The machine learning model 41 used by the information processing device 1 is a summary model based on a Transformer. The information processing device 1 calculates an attention probability considering a coverage without impairing a parallelism that can perform calculation in parallel in a time direction (word (token) sequence of correct summary) at the time of learning the machine learning model 41 based on the Transformer.

Specifically, for example, the information processing device 1 calculates an attention probability at two stages for each token of the input article of the learning case 11 that is an example of a target document. First, the information processing device 1 calculates the attention probability for each token without considering the coverage at the first stage. Next, the information processing device 1 approximatively calculates the coverage on the basis of the attention probability calculated at the first stage for each token. Next, the information processing device 1 calculates the attention probability considering the calculated coverage at the second stage for each token. Next, the information processing device 1 calculates a generation probability for making the token be included in the summary sentence on the basis of the attention probability calculated at the second stage for each token.

In this way, the information processing device 1 calculates the generation probability for making the token be included in the summary sentence for each token on the basis of the attention probability calculated on the basis of the coverage. Therefore, machine learning of the machine learning model 41 can be performed as adding a coverage loss, and it is possible to expect to further improve summarization accuracy. For example, automatic summarization using the machine learning model 41 through machine learning as adding the coverage loss can prevent the token from being repeatedly generated, and an accurate summary sentence can be generated.

Specifically, for example, the information processing device 17 includes an input unit 10, a calculation processing unit 20, a machine learning model generation unit 30, a storage unit 40, an estimation unit 50, and an output unit 60.

The input unit 10 is a processing unit that receives input of various types of information by communicating with an external device, reading data from a storage medium such as a semiconductor memory, or the like and executes preprocessing on the received data. The input unit 10 receives, for example, data of the learning case 11 regarding generation (learning) of a machine learning model used to create a summary sentence or data of the input article 12 that is a summary sentence creation target. The input unit 10 divides the received data of the learning case 11 or the input article 12 into words (token) through known document analysis processing.

The calculation processing unit 20 is a processing unit that executes calculation processing at the time of learning of the machine learning model 41 using the learning case 11. The calculation processing unit 20 includes a first attention calculation unit 21, a coverage calculation unit 22, a second attention calculation unit 23, and a word generation probability calculation unit 24.

The first attention calculation unit 21 calculates an attention score (first attention probability) indicating an attention at the time of summarization of each token divided from the learning case 11 for each token sequence with a known method of the Transformer in parallel. For example, the calculation of the first attention probability of each token by the first attention calculation unit 21 is as indicated in the following formula (1).

$$\begin{matrix}[ Expression 1 ] & \\ \begin{matrix}{q}_{t} = {W}_{q} {s}_{t} \\ {k}_{i} = {W}_{k} {h}_{i} \\ {z}_{t , i} = \frac{{q}_{t} {k}_{i}}{\sqrt{d}} \\ {a}_{t , i} = exp ( {z}_{t , i} ) / {\sum }_{j} exp ( {z}_{t , j} )\end{matrix} \} & ( 1 )\end{matrix}$$

In the formula (1), q indicates Query, k indicates Key, and v indicates Value. The reference sₜ indicates a hidden state (vector) at a time (t) of summarization. The reference hᵢ indicates a hidden state of an i-th word (token) of input text. The reference W* indicates a parameter (* is any one of q, k, and v) of the Transformer. The reference d indicates a dimension of sₜ. The reference a_{t,i} indicates an attention probability (attention score) of the i-th word (token) at the time (t).

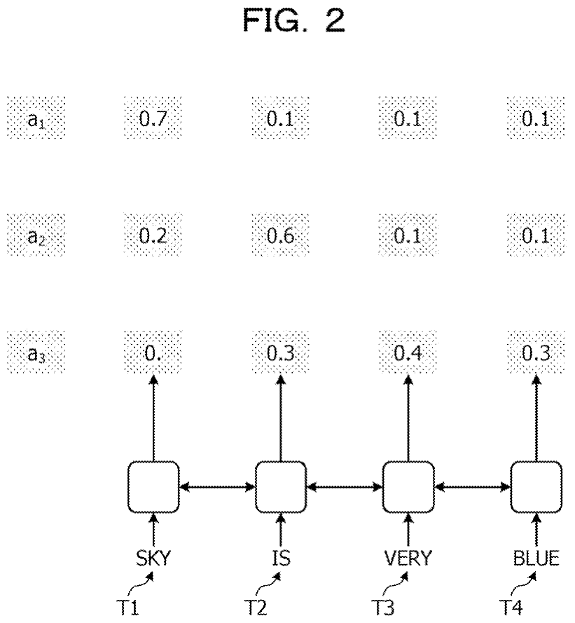

FIG. 2 is an explanatory diagram for explaining a calculation example of a first attention probability. As illustrated in FIG. 2, the first attention calculation unit 21 calculates first attention probabilities (a₁, a₂, and a₃ . . . ) at each time (1, 2, and 3 . . . ) of tokens T1, T2, T3, T4 . . . such as “sky”, “is”, “very”, “blue” according to the formula (1).

For example, the attention probability of the token T1 “sky” at the time (1) is 0.7. The attention probability of the token T2 “is” is 0.1. The attention probability of the token T3 “very” is 0.1. The attention probability of the token T4 “blue” is 0.1. Therefore, the token having the highest attention probability at the time (1) in the word (token) sequence of the correct summary is the token T1 “sky”.

Similarly, an attention probability at the time (2) of the token T1 “sky” is 0.2, an attention probability of the token T2 “is” is 0.6, an attention probability of the token T3 “very” is 0.1, and an attention probability of the token T4 “blue” is 0.1. Therefore, the token having the highest attention probability at the time (2) is the token T2 “is”.

Furthermore, an attention probability at the time (3) of the token T1 “sky” is 0, an attention probability of the token T2 “is” is 0.3, an attention probability of the token T3 “very” is 0.4, and an attention probability of the token T4 “blue” is 0.3. Therefore, the token having the highest attention probability at the time (3) is the token T2 “very”.

The coverage calculation unit 22 calculates a coverage score of each token on the basis of the first attention probability of each token calculated by the first attention calculation unit 21. Specifically, for example, when it is assumed that a coverage score of an i-th word (token) at a time (t) be c_{t,i}, the coverage calculation unit 22 calculates c_{t,i} as a sum up to a time (t−1) of a_{t,i}.

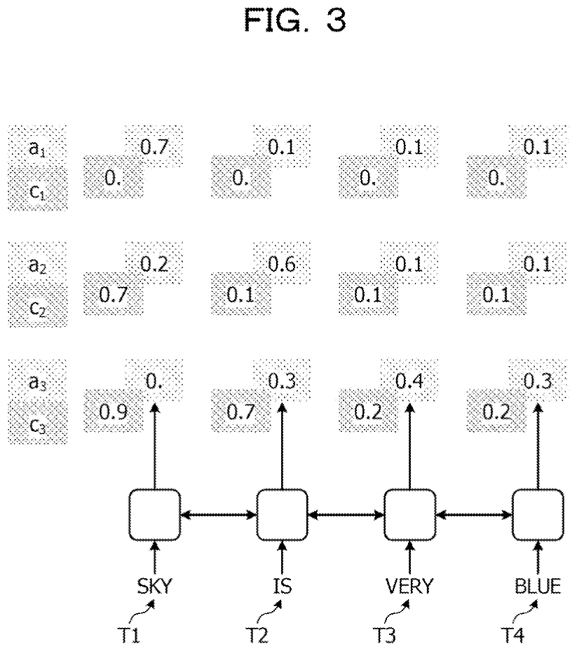

FIG. 3 is an explanatory diagram for explaining a coverage calculation example. As illustrated in FIG. 3, the coverage calculation unit 22 calculates a coverage score according to a sum of the attention probabilities up to the previous time for each token.

For example, a coverage score (c₁) of the token T1 “sky” at the time (1) is zero. Next, a coverage score (c₂) at the time (2) is 0.7 according to a sum of the attention probabilities (a₁) up to the previous time. Next, a coverage score (c₃) at the time (3) is 0.9 according to a sum (0.7+0.2) of the attention probabilities (a₁, a₂) up to the previous time.

The second attention calculation unit 23 calculates a second attention probability of each token in a token sequence in parallel by applying a known method of the Transformer on the basis of the coverage score of each token calculated by the coverage calculation unit 22. For example, the calculation of the second attention probability of each token by the second attention calculation unit 23 is as indicated in the following formula (2).

$$\begin{matrix}[ Expression 2 ] & \\ \begin{matrix}{q}_{t} = {W}_{q} {s}_{t} \\ {k}_{i} = {W}_{k} {h}_{i} \\ {z}_{t , i} = \frac{{q}_{t} {k}_{i}}{\sqrt{d}} + {w}_{c} {c}_{t , i} \\ {a}_{t , i} = exp ( {z}_{t , i} ) / {\sum }_{j} exp ( {z}_{t , j} )\end{matrix} \} & ( 2 )\end{matrix}$$

In the formula (2), the reference w_{c} is a parameter for the coverage. As indicated in the formula (2), the calculation of the second attention probability (a_{t,i}) is performed considering a coverage including a term regarding a coverage score (w_{c}c_{t,i}).

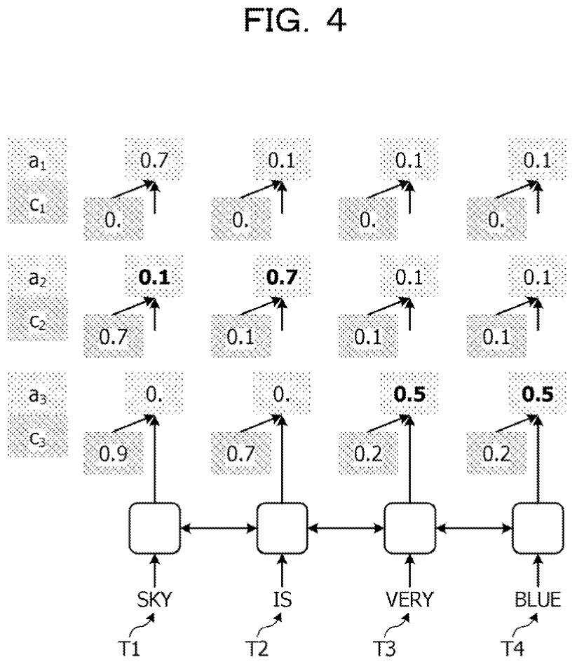

FIG. 4 is an explanatory diagram for explaining a calculation example of a second attention probability. As illustrated in FIG. 4, the second attention calculation unit 23 calculates second attention probabilities (a₁, a₂, and a₃ . . . ) at each time (1, 2, and 3 . . . ) of the tokens T1, T2, T3, T4 . . . such as “sky”, “is”, “very”, “blue” . . . according to the formula (2) on the basis of the coverage scores (c₁, c₂, and c₃).

For example, an attention probability at the time (2) of the token T1 “sky” is 0.1, an attention probability of the token T2 “is” is 0.7, an attention probability of the token T3 “very” is 0.1, and an attention probability of the token T4 “blue” is 0.1. When being compared with the first attention probabilities in FIG. 2, the second attention probability in FIG. 4 of the token T1 is changed from 0.2 to 0.1, and the second attention probability of the token T2 is changed from 0.6 to 0.7.

Furthermore, an attention probability at the time (3) of the token T1 “sky” is 0, an attention probability of the token T2 “is” is 0, an attention probability of the token T3 “very” is 0.5, and an attention probability of the token T4 “blue” is 0.5. When being compared with the first attention probabilities in FIG. 2, the second attention probability in FIG. 4 of the token T3 is changed from 0.4 to 0.5, and the second attention probability of the token T4 is changed from 0.3 to 0.5.

The word generation probability calculation unit 24 calculates a generation probability for making the token be included in the summary sentence from the input article of the learning case 11 for each token on the basis of the second attention probability of each token (word) calculated by the second attention calculation unit 23. Note that, when the word generation probability calculation unit 24 obtains the generation probability for each token, other hidden states (parameter) other than the second attention probability may be used.

Specifically, for example, the word generation probability calculation unit 24 obtains a conditional generation probability (p) of each token in a case where the tokens such as “sky”, “is”, or “blue” are arranged to form a summary sentence from the second attention probability and the other hidden state of each token (word). As a result, the calculation processing unit 20 can set the arrangement of the tokens with the highest probability as a summary sentence.

For example, the word generation probability calculation unit 24 obtains p (sky|^{BOS}), p (is|sky,^{BOS}), p (blue|sky, is,^{BOS}) . . . at each time. As a result, the calculation processing unit 20 can obtain a summary sentence in which “sky”, “is”, and “blue” are arranged, from a distribution of the generation probability of each token at each time. Note that the BOS is a symbol indicating beginning of a summary.

The machine learning model generation unit 30 is a processing unit that generates the machine learning model 41 on the basis of the calculation result of the calculation processing unit 20 and the correct summary sentence included in the learning case 11. Specifically, for example, the machine learning model generation unit 30 calculates a parameter of the machine learning model 41 so that the summary sentence that is the calculation result of the calculation processing unit 20 becomes a correct summary sentence. As an example, the machine learning model generation unit 30 calculates a gradient by the backpropagation using a negative generation probability and a coverage loss of the correct summary sentence as a loss function and sets (learn) a parameter of the machine learning model 41 on the basis of the calculated gradient.

The storage unit 40 is implemented by, for example, a semiconductor memory element such as a random access memory (RAM) or a flash memory or a storage device such as a hard disk or an optical disk. The storage unit 40 stores data of the parameter or the like regarding the machine learning model 41 generated by the machine learning model generation unit 30.

The estimation unit 50 is a processing unit that estimates the summary sentence with respect to the input article 12 on the basis of the learned machine learning model 41 stored in the storage unit 40.

Specifically, for example, the estimation unit 50 constructs the machine learning model 41 on the basis of the parameter read from the storage unit 40. Next, the estimation unit 50 inputs each token divided from the input article 12 into the constructed machine learning model 41 so as to obtain a distribution of the generation probability of each token at each time as output of the machine learning model 41.

Here, in a case where the number of times is equal to or more than two, the estimation unit 50 calculates a coverage score using an attention probability in the past similarly to the coverage calculation unit 22. Next, the estimation unit 50 calculates an attention probability on the basis of the calculated coverage score similarly to the second attention calculation unit 23.

Next, the estimation unit 50 obtains a summary sentence having token arrangement with the highest probability as an estimation result, on the basis of the distribution of the generation probability of each token at each time.

The output unit 60 is a processing unit that outputs the estimation result of the estimation unit 50. Specifically, for example, the output unit 60 outputs the summary sentence estimated by the estimation unit 50 as a display screen or a file. For example, the output unit 60 outputs a display screen in which the input article 12 and the summary sentence estimated from the input article 12 by the estimation unit 50 are arranged.

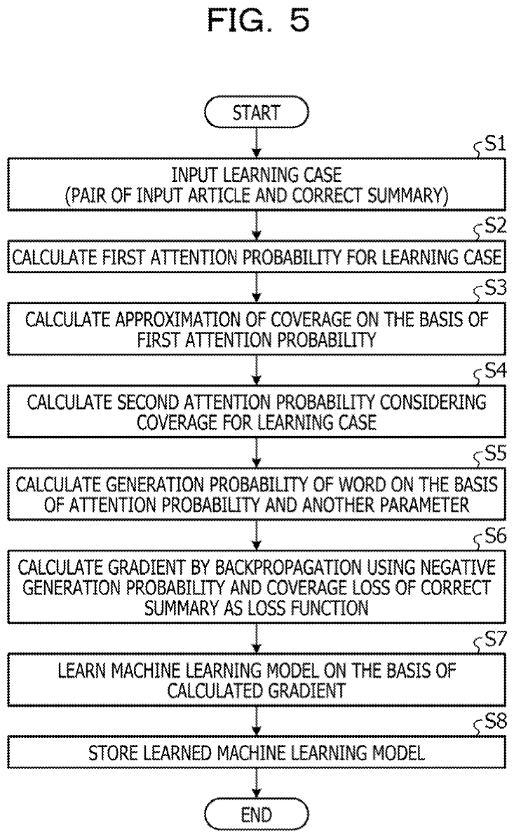

FIG. 5 is a flowchart illustrating an operation example of the information processing device 1 according to the embodiment. Specifically, for example, FIG. 5 illustrates a processing procedure of the information processing device 1 regarding machine learning of the machine learning model 41 according to the learning case 11.

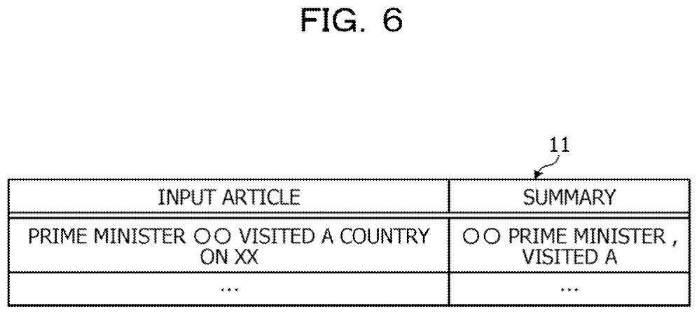

As illustrated in FIG. 5, when processing regarding machine learning is started, the input unit 10 receives input of the learning case 11 (S1) and divides an input article included in the learning case 11 into words (token). FIG. 6 is an explanatory diagram for explaining an example of the learning case 11. As illustrated in FIG. 6, the learning case 11 includes a pair of an input article and a correct summary of the input article.

Next, the first attention calculation unit 21 calculates a first attention probability (first attention probability) for each token divided from the input article for the learning case 11 as indicated in the formula (1) (S2). Next, the coverage calculation unit 22 calculates an approximation of a coverage score on the basis of the first attention probability of each token calculated by the first attention calculation unit 21 (S3).

Next, the second attention calculation unit 23 calculates a second attention probability (second attention probability) considering the coverage for the learning case 11 as indicated in the formula (2) (S4).

Next, the word generation probability calculation unit 24 calculates a generation probability of each word on the basis of the second attention probability of each word calculated by the second attention calculation unit 23 and the other parameter (hidden state) (S5).

Next, the machine learning model generation unit 30 calculates a gradient by the backpropagation using the negative generation probability and the coverage loss of the correct summary included in the learning case 11 as a loss function (S6). Next, the machine learning model generation unit 30 learns a parameter of the machine learning model 41 on the basis of the calculated gradient (S7). The information processing device 1 repeats the processing in S1 to S7 on the plurality of learning cases 11 and learns the parameter of the machine learning model 41 corresponding to the plurality of learning cases 11.

Next, the machine learning model generation unit 30 stores the learned parameter of the machine learning model 41 according to the learning case 11 in the storage unit 40 (S8) and ends the processing.

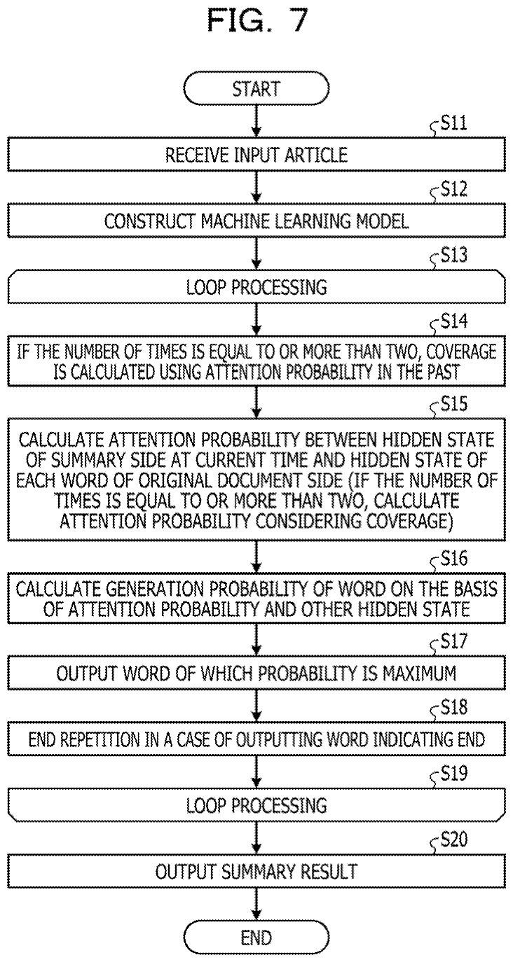

FIG. 7 is a flowchart illustrating an operation example of the information processing device 1 according to the embodiment. Specifically, for example, FIG. 7 illustrates a processing procedure of the information processing device 1 regarding estimation of a summary sentence with respect to the input article 12.

As illustrated in FIG. 7, when the processing regarding the estimation is started, the input unit 10 receives input of the input article 12 (S11) and divides the input article 12 into words (token).

Next, the estimation unit 50 constructs the machine learning model 41 on the basis of a parameter read from the storage unit 40 (S12). Next, the estimation unit 50 executes loop processing (S13 to S19) for inputting each word divided from the input article 12 to the constructed machine learning model 41 and obtaining words used for a summary sentence at each time.

Specifically, for example, in a case where the number of times is equal to or more than two, the estimation unit 50 calculates a coverage score using an attention probability in the past similarly to the coverage calculation unit 22 (S14).

Next, the estimation unit 50 calculates an attention probability between a hidden state of a summary side at a current time and a hidden state of each word of an original document (input article 12) side (S15). Here, in a case where the number of times is equal to or more than two, the estimation unit 50 calculates an attention probability on the basis of the calculated coverage score similarly to the second attention calculation unit 23.

Next, the estimation unit 50 calculates a generation probability of each word on the basis of the attention probability and the other hidden state (parameter) (S16). Next, the estimation unit 50 outputs a word of which the probability is the maximum (S17) and ends the repetition (loop processing) in a case of outputting a word indicating an end (S18). In a case where the word indicating the end is not output in S17, the estimation unit 50 returns the procedure to S13 and continues the loop processing.

The output unit 60 outputs a summary result in which the words obtained by the loop processing by the estimation unit 50 are arranged (S20) and ends the processing.

As described above, the first attention calculation unit 21 of the information processing device 1 calculates a first attention score of each token divided from the target document for a token sequence in parallel. The coverage calculation unit 22 of the information processing device 1 calculates a coverage score of each token on the basis of the calculated first attention score of each token. The second attention calculation unit 23 of the information processing device 1 calculates a second attention score of each token in the token sequence in parallel on the basis of the calculated coverage score of each token. The word generation probability calculation unit 24 of the information processing device 1 calculates a probability (generation probability) for making the token be included in the summary sentence from the target document, for each token, on the basis of the calculated second attention score of each token.

In this way, because the information processing device 1 calculates the probability for making the token be included in the summary sentence from the target document, for each token, on the basis of the attention score calculated on the basis of the coverage score, it is possible to improve summarization accuracy. For example, the information processing device 1 can prevent the word (token) from being repeatedly generated from the target document. Furthermore, because the information processing device 1 calculates the attention scores in the token sequence in parallel, processing can be executed at higher speed than the LSTM.

Furthermore, the coverage calculation unit 22 of the information processing device 1 calculates a coverage score according to the sum of the first attention score for each token in the token sequence calculated in parallel. As a result, the information processing device 1 can obtain the coverage score for each token from the first attention score.

Furthermore, the information processing device 1 includes the machine learning model generation unit 30 that performs machine learning of the machine learning model using the token included in the summary sentence of the target document as a correct answer, using the probability calculated for each token. As a result, the information processing device 1 can generate an accurate machine learning model considering the coverage.

Note that each of the illustrated components in each of the devices is not necessarily physically configured as illustrated in the drawings. In other words, for example, the specific aspects of distribution and integration of the respective devices are not limited to the illustrated aspects, and all or some of the devices may be functionally or physically distributed and integrated in an optional unit according to various loads, use situations, and the like.

Furthermore, various processing functions of the input unit 10, the calculation processing unit 20, the machine learning model generation unit 30, the estimation unit 50, and the output unit 60 of the information processing device 1 may be entirely or optionally partially executed on a central processing unit (CPU) (or microcomputer such as microprocessor unit (MPU) or micro controller unit (MCU)) as an example of a control unit. Furthermore, it is needless to say that whole or any part of the various processing functions may be executed by a program to be analyzed and executed in a CPU (or microcomputer such as MPU or MCU) or in hardware by wired logic. Furthermore, various processing functions executed by the information processing device 1 may be executed by a plurality of computers in cooperation through cloud computing.

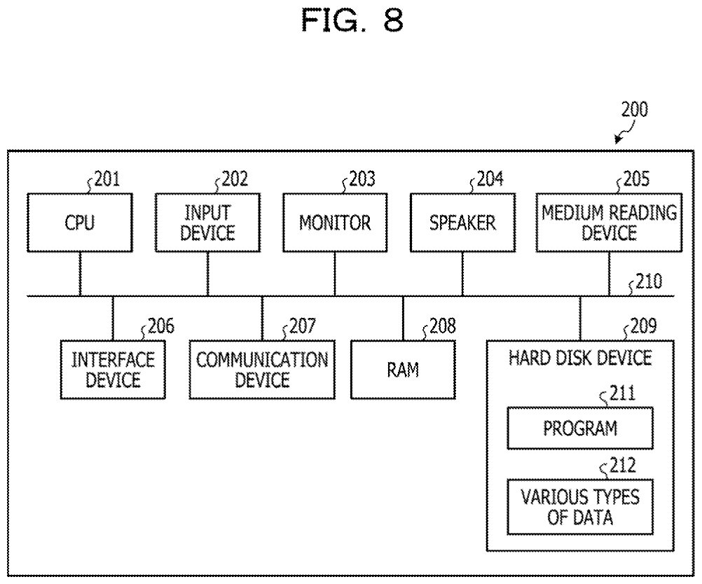

Meanwhile, the various types of processing described in the above embodiment may be implemented by executing a prepared program by a computer. Thus, hereinafter, an example of a computer configuration (hardware) that executes a program having functions similar to the above embodiment will be described. FIG. 8 is an explanatory diagram for explaining an example of a computer configuration.

As illustrated in FIG. 8, a computer 200 includes a CPU 201 that executes various types of arithmetic processing, an input device 202 that receives data input, a monitor 203, and a speaker 204. Furthermore, the computer 200 includes a medium reading device 205 that reads a program and the like from a storage medium, an interface device 206 to be connected to various devices, and a communication device 207 to be connected to and communicate with an external device in a wired or wireless manner. Furthermore, the information processing device 1 further includes a random access memory (RAM) 208 that temporarily stores various types of information, and a hard disk device 209. Furthermore, each of the units (201 to 209) in the computer 200 is connected to a bus 210.

The hard disk device 209 stores a program 211 used to execute various types of processing of the functional configuration (for example, input unit 10, calculation processing unit 20, machine learning model generation unit 30, estimation unit 50, and output unit 60) described in the embodiment above. Furthermore, the hard disk device 209 stores various types of data 212 that the program 211 refers to. The input device 202 receives, for example, input of operation information from an operator. The monitor 203 displays, for example, various screens operated by the operator. The interface device 206 is connected to, for example, a printing device or the like. The communication device 207 is connected to a communication network such as a local area network (LAN), and exchanges various types of information with an external device via the communication network.

The CPU 201 reads the program 211 stored in the hard disk device 209 and develops and executes the program 211 on the RAM 208 so as to execute various types of processing regarding the functional configuration described above (for example, input unit 10, calculation processing unit 20, machine learning model generation unit 30, estimation unit 50, and output unit 60). Note that the program 211 does not need to be prestored in the hard disk device 209. For example, the program 211 stored in a storage medium that is readable by the computer 200 may be read and executed. The storage medium that is readable by the computer 200 corresponds to, for example, a portable recording medium such as a compact disk read only memory (CD-ROM), a digital versatile disk (DVD), or a universal serial bus (USB) memory, a semiconductor memory such as a flash memory, a hard disk drive, or the like. Furthermore, the program 211 may be prestored in a device connected to a public line, the Internet, a LAN, or the like, and the computer 200 may read the program 211 from the device and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute processing comprising:
calculating a first attention score of each token divided from a target document of a token sequence in parallel;
calculating a coverage score of each token on the basis of the calculated first attention score of each token;
calculating a second attention score of each token in the token sequence in parallel on the basis of the calculated coverage score of each token; and
calculating a probability that the token is included in a summary sentence from the target document for each token on the basis of the calculated second attention score of each token.

2. The non-transitory computer-readable recording medium storing the machine learning program according to claim 1, wherein
the processing of calculating the coverage score calculates the coverage score according to a sum of the first attention score for each token in the token sequence calculated in parallel.

3. The non-transitory computer-readable recording medium storing the machine learning program according to claim 1, for causing the computer to further execute processing comprising:
executing machine learning of a machine learning model with a token included in the summary sentence of the target document as a correct answer, by using the probability calculated for each token.

4. A machine learning method comprising:
Calculating, by a computer, a first attention score of each token divided from a target document of a token sequence in parallel;
calculating a coverage score of each token on the basis of the calculated first attention score of each token;
calculating a second attention score of each token in the token sequence in parallel on the basis of the calculated coverage score of each token; and
calculating a probability that the token is included in a summary sentence from the target document for each token on the basis of the calculated second attention score of each token.

5. The machine learning method according to claim 4, wherein
the processing of calculating the coverage score calculates the coverage score according to a sum of the first attention score for each token in the token sequence calculated in parallel.

6. The machine learning method according to claim 4 further comprising:
executing machine learning of a machine learning model with a token included in the summary sentence of the target document as a correct answer, by using the probability calculated for each token.

7. An information processing device comprising:
a memory; and
a processor coupled to the memory and configured to:
calculate a first attention score of each token divided from a target document of a token sequence in parallel;
calculate a coverage score of each token on the basis of the calculated first attention score of each token;
calculating a second attention score of each token in the token sequence in parallel on the basis of the calculated coverage score of each token; and
calculate a probability that the token is included in a summary sentence from the target document for each token on the basis of the calculated second attention score of each token.

8. The information processing device according to claim 8, wherein
the coverage score is calculated according to a sum of the first attention score for each token in the token sequence calculated in parallel.

9. The information processing device according to claim 8, wherein the processor is configured to:
execute machine learning of a machine learning model with a token included in the summary sentence of the target document as a correct answer, by using the probability calculated for each token.
